(19) United States
(12) Patent Application Publication
(10) Pub. No.: US 2023/0411066 A1
(43) Pub. Date: Dec. 21, 2023

(54) TRANSFORMER

(71) Applicants: DENSO CORPORATION, Kariya-city (JP); TOYOTA JIDOSHA KABUSHIKI KAISHA, Toyota-shi, Aichi-ken (JP); MIRISE Technologies Corporation, Nisshin-shi, Aichi-ken (JP)

(72) Inventors: Ryota KOJIMA, Nisshin-shi (JP); Akihiro YAMAGUCHI, Nisshin-shi (JP)

(21) Appl. No.: 18/319,045

(22) Filed: May 17, 2023

(30) Foreign Application Priority Data
Jun. 17, 2022 (JP) 2022-098100

(51) Int. Cl. H01F 27/28; H01F 27/29

(52) U.S. Cl. CPC H01F 27/2804; H01F 2027/2814; H01F 27/292; H01F 27/2885

(57) ABSTRACT

A transformer includes a core and a primary winding, a first secondary winding, and a second secondary winding wound around the core. The first secondary winding includes first winding layers stacked along an axial direction of the core. The second secondary winding includes second winding layers stacked along the axial direction. The first winding layers are electrically connected in parallel to each other. The second winding layers are electrically connected in parallel to each other. A distance between the primary winding and the first secondary winding and a distance between the primary winding and the second secondary winding are greater than a distance between adjacent two of the first winding layers and a distance between adjacent two of the second winding layers.

### CROSS REFERENCE TO RELATED APPLICATION

The present application claims the benefit of priority from Japanese Patent Application No. 2022-098100 filed on Jun. 17, 2022. The entire disclosure of the above application is incorporated herein by reference.

### TECHNICAL FIELD

The present disclosure relates to a transformer.

### BACKGROUND

Conventionally, there has been known a transformer including a primary winding and a secondary winding.

### SUMMARY

The present disclosure provides a transformer including a core and a primary winding, a first secondary winding, and a second secondary winding wound around the core. The first secondary winding includes first winding layers stacked along an axial direction of the core. The second secondary winding includes second winding layers stacked along the axial direction. The first winding layers are electrically connected in parallel to each other. The second winding layers are electrically connected in parallel to each other. A distance between the primary winding and the first secondary winding and a distance between the primary winding and the second secondary winding are greater than a distance between adjacent two of the first winding layers and a distance between adjacent two of the second winding layers.

### BRIEF DESCRIPTION OF DRAWINGS

Objects, features and advantages of the present disclosure will become apparent from the following detailed description made with reference to the accompanying drawings. In the drawings:

FIG. 1 is a circuit diagram of a direct current to direct current (DC/DC) converter;

FIG. 2 is an exploded perspective view of winding layers of a transformer according to a first embodiment;

FIG. 3 is a cross-sectional view of the winding layers of the transformer according to the first embodiment;

FIG. 4 is a plan view of the winding layers of the transformer according to the first embodiment;

FIG. 5 is a circuit diagram of the transformer according to the first embodiment;

FIG. 6 is an exploded perspective view for explaining a configuration of the transformer according to the first embodiment;

FIG. 7 is an exploded side view for explaining the configuration of the transformer according to the first embodiment;

FIG. 8 is a diagram illustrating thicknesses of the winding layers and insulating layers;

FIG. 9 is a cross-sectional view for explaining a displacement current that flows through the transformer;

FIG. 10 is a diagram illustrating a relationship between a frequency of an alternating current that flows through the winding layers and a skin depth;

FIG. 11 is an exploded perspective view for explaining a configuration of a transformer according to a second embodiment;

FIG. 12 is an exploded perspective view for explaining a configuration of a transformer according to a third embodiment; and

FIG. 13 is an exploded perspective view for explaining a configuration of a transformer according to a modification.

### DETAILED DESCRIPTION

Next, a relevant technology is described only for understanding the following embodiments. A power conversion device according to a relevant technology includes a transformer having a primary winding and a secondary winding. In the transformer, the primary winding includes three winding layers, and the secondary winding includes two winding layers. The winding layers included in the primary winding and the winding layers included in the secondary winding are alternately stacked.

When a current flows through two windings close to each other, a Lorentz force acts on electrons flowing through one winding due to the influence of a magnetic field generated around the other winding, and a phenomenon (proximity effect) occurs in which a bias occurs in the current flowing through the winding. When the proximity effect occurs, the resistance of the winding increases, and the winding loss (copper loss) increases. In the transformer, the winding layers included in the primary winding and the winding layers included in the secondary winding are alternately arranged. That is, the current flowing through a certain winding flows in the opposite direction to the current flowing through the windings located on both sides of the certain winding. Therefore, the influence of the magnetic field acting on the certain winding is canceled out, and the current distribution in the winding is made uniform. Accordingly, the winding loss can be reduced.

When the power conversion device is used, a difference occurs between a voltage applied to the primary winding and a voltage applied to the secondary winding. Therefore, parasitic capacitance occurs between the winding layers included in the primary winding and the winding layers included in the secondary winding. As a result of intensive studies by the present inventors, it has been found that a magnetic flux density inside a core increases due to a magnetic flux generated by a current flowing through the parasitic capacitance (hereinafter, referred to as a displacement current in the present specification), and a core loss (iron loss) increases.

A transformer according to one aspect of the present disclosure includes a core, a primary winding wound around the core, a first secondary winding wound around the core, and a second secondary winding wound around the core. The first secondary winding includes first winding layers stacked along an axial direction of the core. The second secondary winding includes second winding layers stacked along the axial direction. The first winding layers are electrically connected in parallel to each other. The second winding layers are electrically connected in parallel to each other. A distance between the primary winding and the first secondary winding is greater than a distance between adjacent two of the first winding layers and a distance between adjacent two of the second winding layers. A distance between the primary winding and the second secondary winding is greater than the distance between the adjacent two of the first winding layers and the distance between the adjacent two of the second winding layers.

In the transformer according to the one aspect of the present disclosure, the first secondary winding includes the first winding layers stacked along the axial direction of the core. Since the first winding layers are electrically connected in parallel to each other, a potential difference hardly occurs between the first winding layers, and parasitic capacitance hardly occurs between the first winding layers. In addition, the second secondary winding includes the second winding layers stacked along the axial direction of the core. Since the second winding layers are electrically connected in parallel to each other, a potential difference hardly occurs between the second winding layers, and parasitic capacitance hardly occurs between the second winding layers. On the other hand, since a potential difference occurs between the primary winding and the first secondary winding, a parasitic capacitance occurs between the primary winding and the first secondary winding. However, since the distance between the primary winding and the first secondary winding is greater than the distance between the adjacent two of the first winding layers and the distance between the adjacent two of the second winding layers, the parasitic capacitance between the primary winding and the first secondary winding is small. In addition, since a potential difference occurs between the primary winding and the second secondary winding, a parasitic capacitance occurs between the primary winding and the second secondary winding. However, since the distance between the primary winding and the second secondary winding is greater than the distance between the adjacent two of the first winding layers and the distance between the adjacent two of the second winding layers, the parasitic capacitance between the primary winding and the second secondary winding is small. Thus, in the transformer according to the one aspect of the present disclosure, the parasitic capacitance generated between the windings can be reduced. Therefore, the influence of the magnetic flux generated by the current flowing through the parasitic capacitance is reduced, and the core loss can be reduced. In addition, in the transformer according to the one aspect of the present disclosure, the winding loss is increased as compared with the transformer of the relevant technology, but the total loss of the winding loss and the core loss can be reduced as compared with the transformer of the relevant technology.

In the transformer according to the one aspect of the present disclosure, the primary winding may include a winding layer, the number of turns of the winding layer may be two or more, and the number of turns of each of the first winding layers and the number of turns of each the second winding layers may be one.

The first winding layers and the second winding layers may be disposed on the outermost layers of the winding layers. In the above configuration, by disposing the winding layers having a small number of turns (that is, a large surface area) on the outermost layers, the heat dissipation area is increased, and the heat dissipation performance can be improved.

In the transformer according to the one aspect of the present disclosure, the primary winding, the first secondary winding, and the second secondary winding may be stacked along the axial direction such that the primary winding is located between the first secondary winding and the second secondary winding.

During operation of the transformer, current flows through the primary winding and the secondary windings in opposite directions. Therefore, the proximity effect can be restricted, and an increase in winding loss can be restricted.

In the transformer according to the one aspect of the present disclosure, the primary winding may include two third winding layers stacked along the axial direction. The two third winding layers may be electrically connected in series. A distance between the two third winding layers may be greater than the distance between the adjacent two of the first winding layers and the distance between the adjacent two of the second winding layers.

When the transformer operates, a potential difference occurs between the two third winding layers connected in series. Therefore, by making the distance between the two third winding layers relatively large, the parasitic capacitance between the third winding layers can be reduced, and the core loss can be reduced.

In the transformer according to the one aspect, each of conductors included in the primary winding, the first secondary winding, and the third secondary winding may satisfy a relationship of 2δ≤t≤4δ, where t is a thickness of each of the conductors in the axial direction of the core, and δ is a skin depth of each of the conductors.

When a high-frequency alternating current flows through a winding, a phenomenon (skin effect) occurs in which the current density decreases from a surface of the winding toward a center of the winding due to the influence of the generated magnetic field. In the above configuration, since the thickness of the conductor is two times or more and four times or less the skin depth (the depth at which the current is 1/e of the current flowing through the conductor surface), the influence of the skin effect on the AC resistance can be effectively reduced.

In the transformer according to the one aspect of the present disclosure, the thickness of the conductor included in the first secondary winding and the thickness of the conductor included in the second secondary winding may be greater than the thickness of the conductor included in the primary winding.

In the above configuration, the resistance of the secondary winding can be reduced, and the winding loss can be further reduced. In addition, by increasing the thickness of the secondary windings, the heat dissipation area is increased, and the heat dissipation performance can be improved.

In the transformer according to the one aspect of the present disclosure, each of the first secondary winding and the second secondary winding may have a center tap at an end portion. The center tap may be grounded through a terminal.

During operation of the transformer, warpage may occur in each of the winding layers due to the influence of heat generation. In the configuration, since the center tap is grounded through the terminal, the center tap is less likely to be affected by warpage of each of the winding layers, and the center tap can be grounded more reliably.

In the transformer according to the one aspect of the present disclosure, the first winding layers and the second winding layers may be disposed on a printed circuit board. The printed circuit board may have a shield layer on a surface facing the core.

In the above configuration, the magnetic flux generated by the displacement current can be shielded by the shield layer. Therefore, the influence of the magnetic flux on the core is restricted, and the core loss can be further reduced.

### First Embodiment

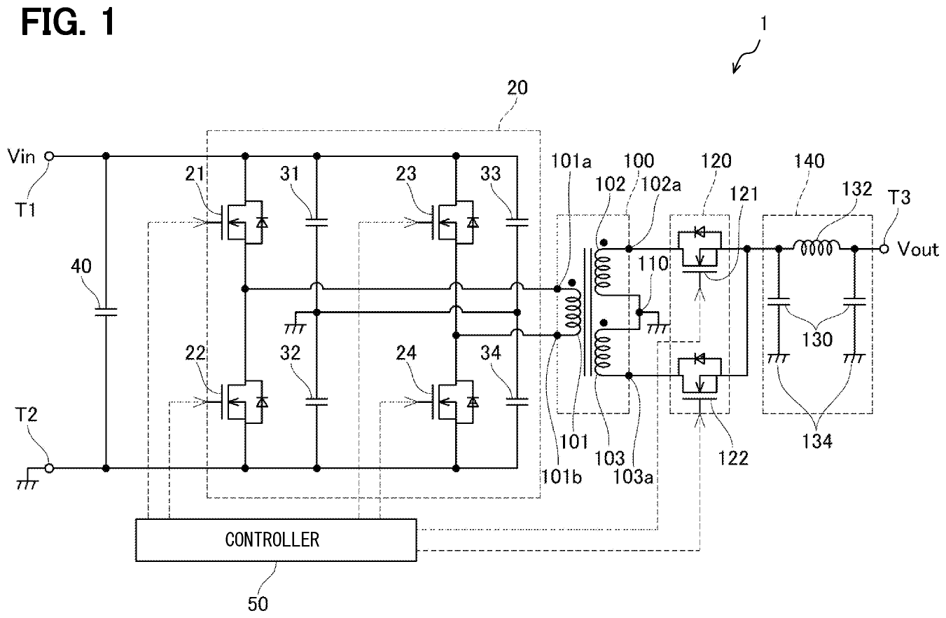

First, a configuration of a direct current to direct current (DC/DC) converter 1 as a power conversion device will be described with reference to FIG. 1. As shown in FIG. 1, the DC/DC converter 1 includes a full bridge circuit 20, a smoothing capacitor 40 connected in parallel to the full bridge circuit 20, a transformer 100, a rectifier circuit 120, a smoothing circuit 140, and a controller 50. These components are fixed to a housing (not shown), and the housing functions as a ground line.

The full bridge circuit 20 includes switching elements 21, 22, 23, and 24. Each of the switching elements 21 to 24 converts an input direct current (DC) voltage applied between input terminals T1 and T2 into an input alternating current (AC) voltage based on a drive signal input from the controller 50. The switching elements 21 to 24 are not particularly limited, and for example, power semiconductor elements such as MOSFETs or IGBTs are used.

The smoothing capacitor 40 has a function of absorbing an AC component generated by the operation of the full bridge circuit 20 and restricting the generation of noise in an input line. The full bridge circuit 20 further includes capacitors 31, 32, 33, and 34. Each of the capacitors 31 to 34 is interposed between the input line and the ground, and has a function of bypassing common mode noise generated between the input line and the ground.

The transformer 100 transforms the input AC voltage generated by the full bridge circuit 20 and outputs an output AC voltage. The transformer 100 includes a primary winding 101, a first secondary windings 102, and a second secondary winding 103. The number of turns of the primary winding 101 is larger than the number of turns of the secondary windings 102 and 103, and the ratio of the number of turns of the primary winding 101 to the number of turns of the secondary windings 102 and 103 is appropriately set according to a transformation ratio. A center tap 110 is provided between the first secondary winding 102 and the second secondary winding 103, and the center tap 110 is connected to the housing. That is, the center tap 110 is grounded.

The rectifier circuit 120 is a single-phase full-wave rectifier including rectifying elements 121 and 122 each having a drain and a source. The drain of the rectifying element 121 is connected to the first secondary winding 102. The source of the rectifying element 121 is connected to the smoothing circuit 140. The drain of the rectifying element 122 is connected to the second secondary winding 103. The source of the rectifying element 122 is connected to the smoothing circuit 140. The rectifier circuit 120 individually rectifies the output AC voltage output from the transformer 100 based on the drive signal input from the controller 50 to generate a DC voltage.

The smoothing circuit 140 includes two capacitors 130 and one choke coil 132. The smoothing circuit 140 smooths the DC voltage rectified by the rectifier circuit 120, generates an output DC voltage, and supplies the output DC voltage from an output positive terminal T3 to a low-voltage battery or the like. The ground 134 corresponds to an output negative electrode terminal.

In the DC/DC converter 1, an input DC voltage Vin is supplied from the input terminals T1 and T2 and converted into the input AC voltage by the full bridge circuit 20. The input AC voltage is supplied to the primary winding 101 of the transformer 100 to be transformed, and is output from the secondary windings 102 and 103 as the output AC voltage. The output AC voltage is rectified by the rectifier circuit 120, smoothed by the smoothing circuit 140, and output as an output DC voltage Vout from the output positive terminal T3. For example, the DC/DC converter 1 is mounted on a vehicle, transforms the input DC voltage Vin of 100 to 500 V supplied to the input terminals T1 and T2 into the output DC voltage Vout of about 12 to 16 V, which is a power supply voltage of an in-vehicle auxiliary system component, and outputs the output DC voltage Vout from the output positive terminal T3.

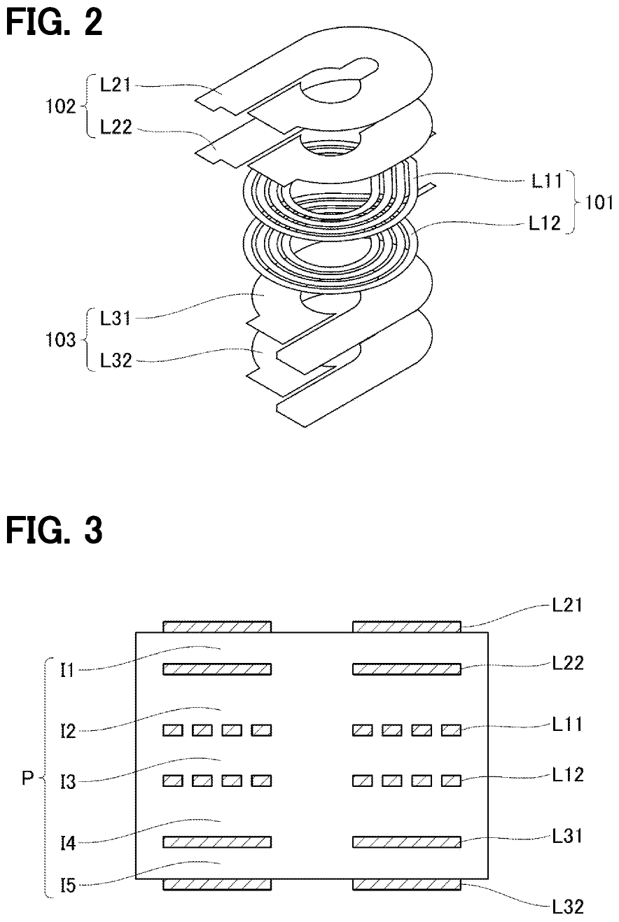

Next, a configuration of the transformer 100 will be described in detail. FIG. 2 is an exploded perspective view of the windings included in the transformer 100. In FIG. 2, a part of the configuration such as a magnetic core component 200, a substrate P, and the like of the transformer 100 is omitted for ease of illustration. The transformer 100 includes two winding layers L11 and L12 included in the primary winding 101, two winding layers L21 and L22 included in the first secondary winding 102, and two winding layers L31 and L32 included in the second secondary winding 103. Each of the winding layers L11 to L32 is made of copper. The winding layers L11 and L12 are stacked adjacent to each other, the winding layers L21 and L22 are stacked adjacent to each other, and the winding layers L31 and L32 are stacked adjacent to each other. The winding layers L11 and L12 are disposed between the winding layers L21 and L22 and the winding layers L31 and L32. That is, the primary winding 101 is stacked so as to be located between the first secondary winding 102 and the second secondary winding 103. The winding layers L21 and L22 are examples of “first winding layers”. The winding layers L31 and L32 are examples of “second winding layers”. The winding layers L11 and L12 are examples of “third winding layers”. Each of the winding layers L11 to L32 is an example of a “conductor”.

As shown in FIG. 3, the winding layers L11 to L32 of the transformer 100 are separated from each other by insulating layers 11 to 15. The winding layer L21 is provided on an upper surface of the insulating layer 11. The winding layer L22 is sandwiched between the insulating layer 11 and the insulating layer 12. The winding layer L11 is sandwiched between the insulating layer 12 and the insulating layer 13. The winding layer L12 is sandwiched between the insulating layer 13 and the insulating layer 14. The winding layer L31 is sandwiched between the insulating layer 14 and the insulating layer 15. The winding layer L32 is provided on a lower surface of the insulating layer 15. The insulating layer 11 and the insulating layer 12 are connected to each other in a range in which the winding layer L22 is not present. The insulating layer 12 and the insulating layer 13 are connected to each other in a range in which the winding layer L11 is not present. The insulating layer 13 and the insulating layer 14 are connected to each other in a range in which the winding layer L12 is not present. The insulating layer 14 and the insulating layer 15 are connected to each other in a range in which the winding layer L31 is not present. For convenience of description, the insulating layers 11 to 15 are distinguished from each other, but in practice, the insulating layers 11 to 15 are integrally formed and constitute the substrate P. In the present embodiment, the substrate P is made of a thermosetting resin (for example, epoxy glass). The substrate P is an example of a “printed circuit board”.

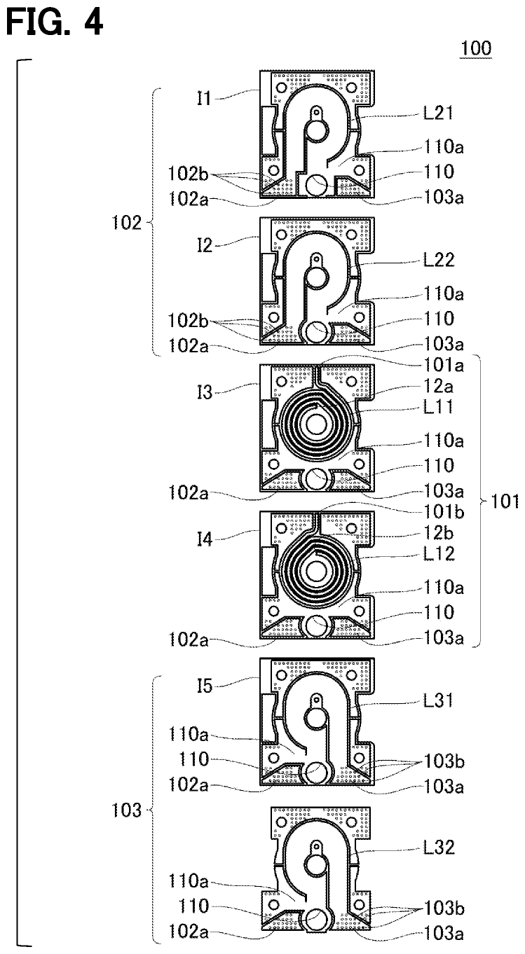

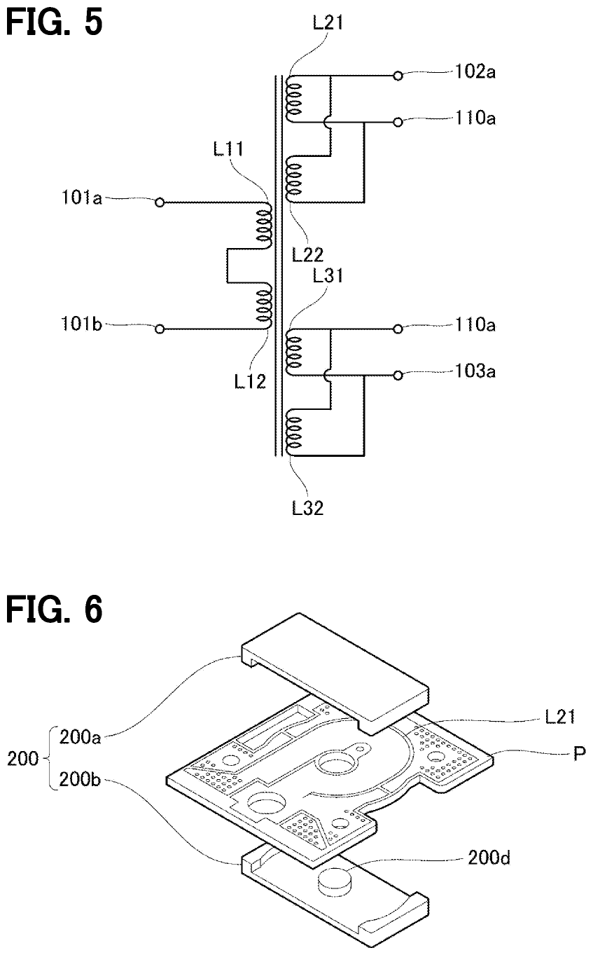

FIG. 4 is a plan view in which the primary winding 101 and the secondary windings 102 and 103 are separated into layers. As described above, the insulating layers 11 to 15 are actually integrated, but FIG. 4 is illustrated in a state in which the insulating layers 11 to 15 are disassembled. First, the primary winding 101 will be described. As described above, the primary winding 101 includes the two winding layers L11 and L12, and the number of turns of each of the winding layers L11 and L12 is four. As shown in FIG. 4, a through hole 12a is provided at one end of the winding layer L11. A through hole 12b is provided at one end of the winding layer L12. The winding layer L11 and the winding layer L12 are electrically connected to each other through the through holes 12a and 12b. That is, as shown in FIG. 5, the winding layer L11 and the winding layer L12 are connected in series. Therefore, in the present embodiment, the number of turns of the primary winding 101 is eight. For example, a current flowing from one end 101a of the winding layer L11 (see FIG. 1) flows through the winding layer L11, flows into the winding layer L12 through the through holes 12a and 12b, and flows out from one end 101b of the winding layer L12.

Next, the first secondary winding 102 will be described. As described above, the first secondary winding 102 includes the two winding layers L21 and L22, and the number of turns of each of the winding layers L21 and L22 is one. As shown in FIG. 4, a first output wiring 102a (see also FIG. 1) is provided at one end of each of the winding layers L21 and L22. Each of the first output wirings 102a includes multiple vias 102b, and the first output wirings 102a are electrically connected to each other through the vias 102b. The first output wirings 102a including multiple vias 102b are also provided in layers in which the winding layers L11, L12, L31, and L32 are provided. All of the first output wirings 102a provided in the respective layers are electrically connected through the vias 102b. However, the winding layers L11, L12, L31, and L32 are electrically insulated from the first output wirings 102a. A center tap wiring 110a is provided at the other end of each of the winding layers L21 and L22. The center tap wirings 110a are electrically connected to each other via the center tap 110. The center tap wirings 110a are also provided in the layers in which the winding layers L11, L12, L31, and L32 are provided. All the center tap wirings 110a provided in the respective layers are electrically connected through the center tap 110. However, the winding layers L11 and L12 are electrically insulated from the center tap wirings 110a. When the DC/DC converter 1 operates, a current flows from the center tap wiring 110a to the first output wiring 102a in each of the winding layers L21 and L22. As shown in FIG. 5, the winding layers L21 and L22 are connected in parallel to each other.

Next, the second secondary winding 103 will be described. As described above, the second secondary winding 103 includes the two winding layers L31 and L32, and the number of turns of each of the winding layers L31 and L32 is one. As shown in FIG. 4, a second output wiring 103a (see also FIG. 1) is provided at one end of each of the winding layers L31 and L32. Each of the second output wirings 103a includes multiple vias 103b, and the second output wirings 103a are electrically connected to each other through the vias 103b. The second output wiring 103a including multiple vias 103b are also provided in the layers in which the winding layers 11, L12, L21, and L22 are provided. All the second output wirings 103a provided in the respective layers are electrically connected through the vias 103b. However, the winding layers L11, L12, L21, and L22 are electrically insulated from the second output wirings 103a. A center tap wiring 110a is provided at the other end of each of the winding layers L31 and L32. The center tap wirings 110a are electrically connected to each other via the center tap 110. When the DC/DC converter 1 operates, a current flows from the center tap wiring 110a to the second output wiring 103a in each of the winding layers L31 and L32. As shown in FIG. 5, the winding layers L31 and L32 are connected in parallel to each other.

As described above, in the transformer 100, the primary winding 101 has eight turns, the first secondary winding 102 has one turn, and the second secondary winding 103 has one turn. That is, the transformer 100 has a transformation ratio of 8:1:1.

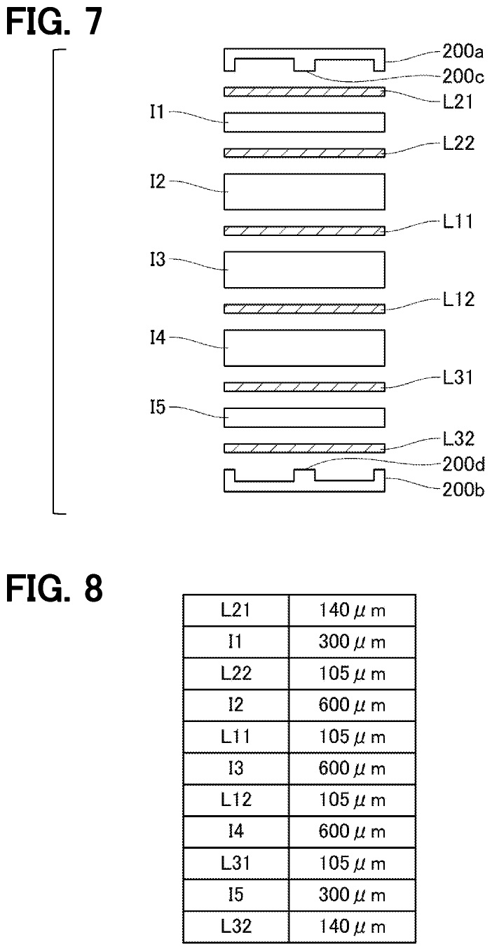

As shown in FIG. 6 and FIG. 7, the transformer 100 includes the magnetic core component 200. The magnetic core component 200 includes a pair of E-shaped core portions 200a and 200b disposed to face each other. The core portions 200a and 200b are made of, for example, Mn—Zn-based ferrite. Since FIG. 6 shows a state in which the winding layers L11 to L32 are integrated with the substrate P (that is, the state shown in FIG. 3), only the winding layer L21 exposed on the surface of the substrate P can be seen in FIG. 6.

As shown in FIG. 6 and FIG. 7, the winding layers L11 to L32 are inserted into protruding portions 200c and 200d respectively protruding from centers of the core portions 200a and 200b. An end surface of the protruding portion 200c is connected to an end surface of the protruding portion 200d. The protruding portions 200c and 200d connected to each other constitute a core 200x (see FIG. 9). The core 200x extends so as to pass through the centers of the winding layers 11, L12, L21, L22, L31, and L32. Therefore, the winding layers 11, L12, L21, L22, L31, and L32 are wound around the core 200x. The winding layers 11, L12, L21, L22, L31, and L32 are stacked along an axial direction of the core 200x.

FIG. 8 shows the thickness of each of the winding layers L11 to L32 and the thickness of each of the insulating layers 11 to 15. As shown in FIG. 8, in the present embodiment, the thickness of the winding layer L21 and the thickness of the winding layer L32 are 140 μm, and the thicknesses of the other winding layers L22, 11, L12, and L31 are 105 μm. Regarding the insulating layers 11 to 15, the thickness of each of the insulating layers 11 and 15 is 300 μm, and the thickness of each of the insulating layers 12 to 14 is 600 μm. In other words, the distance between the winding layers L22 and L11 is greater than the distance between the winding layers L21 and L22 and the distance between the winding layers L31 and L32. In addition, the distance between the winding layers L11 and L12 is greater than the distance between the winding layers L21 and L22 and the distance between the winding layers L31 and L32. Furthermore, the distance between the winding layers L12 and L31 is larger than the distance between the winding layers L21 and L22 and the distance between the winding layers L31 and L32.

In the transformer 100 of the present embodiment, the first secondary winding 102 includes the two winding layers L21 and L22 connected in parallel to each other, and the second secondary winding 103 includes the two winding layers L31 and L32 connected in parallel to each other. Since each of the secondary windings 102 and 103 is constituted of the two winding layers L21 to L32 connected in parallel, the resistances of the windings are reduced, and as a result, the winding loss is reduced. In the transformer 100 of the present embodiment, the primary winding 101 is stacked along the axial direction of the core 200x so as to be positioned between the first secondary winding 102 and the second secondary winding 103. Since currents flow in the primary winding 101 and the secondary windings 102 and 103 in opposite directions, the proximity effect can be restricted, and an increase in winding loss can be restricted.

During operation of the transformer 100, a potential difference occurs between the primary winding 101 and the secondary windings 102 and 103. A potential difference also occurs between the winding layers L11 and L12 included in the primary winding 101. Therefore, as shown in FIG. 9, displacement currents 300 flow due to the parasitic capacitance generated between the windings in which the potential difference is generated. The displacement currents 300 generate a magnetic flux in a direction perpendicular to a paper plane of FIG. 9. When the magnetic flux penetrates the core 200x, a magnetic flux density inside the core 200x increases, and the core loss increases. In the transformer 100 of the present embodiment, each of the distance between the winding layer L11 and the winding layer L22, the distance between the winding layer L12 and the winding layer L31, and the distance between the winding layer L11 and the winding layer L12 (that is, the distance between the winding layers at which a potential difference occurs: 600 μm) is larger than the distance between the winding layer L21 and the winding layer L22 and the distance between the winding layer L31 and the winding layer L32 (that is, the distance between the winding layers at which no potential difference occurs: 300 μm). Since the distance between the winding layers where the potential difference occurs is relatively large, the parasitic capacitance between the winding layers is small. Specifically, in the present embodiment, for example, when the distance between the winding layers in which the potential difference occurs is set to be substantially equal to the distance (300 μm) between the winding layers in which the potential difference does not occur, the value of the parasitic capacitance becomes approximately 2 times the value of the parasitic capacitance between the winding layers in which the potential difference occurs. Further, in the transformer 100 of the present embodiment, the winding layers L21 and L22 included in the first secondary winding 102 are stacked along the axial direction of the core 200x, and the winding layers L31 and L32 included in the second secondary winding 103 are stacked along the axial direction of the core 200x. Since the winding layers L21 and L22 are electrically connected in parallel, a potential difference hardly occurs between the winding layers L21 and L22. Similarly, since the winding layers L31 and L32 are electrically connected in parallel, a potential difference hardly occurs between the winding layers L31 and L32. Therefore, for example, compared to a case where the winding layers included in the primary winding and the winding layers included in the secondary winding are alternately arranged, the number of places where a potential difference occurs is small. Therefore, in the present embodiment, the parasitic capacitance of the entire transformer 100 can be reduced, the influence of the magnetic flux due to the current flowing through the parasitic capacitance is reduced, and the core loss can be reduced. As described above, in the transformer 100 of the present embodiment, the loss of the transformer 100 can be reduced.

In the present embodiment, the secondary windings 102 and 103 (more specifically, the winding layers L21 and L32) are arranged in the outermost layers. The number of turns of the winding layers L21 and L32 is one, and by arranging the winding layers L21 and L32 having a small number of turns (that is, a large surface area) in the outermost layers, the heat dissipation area is increased, and the heat dissipation performance can be improved.

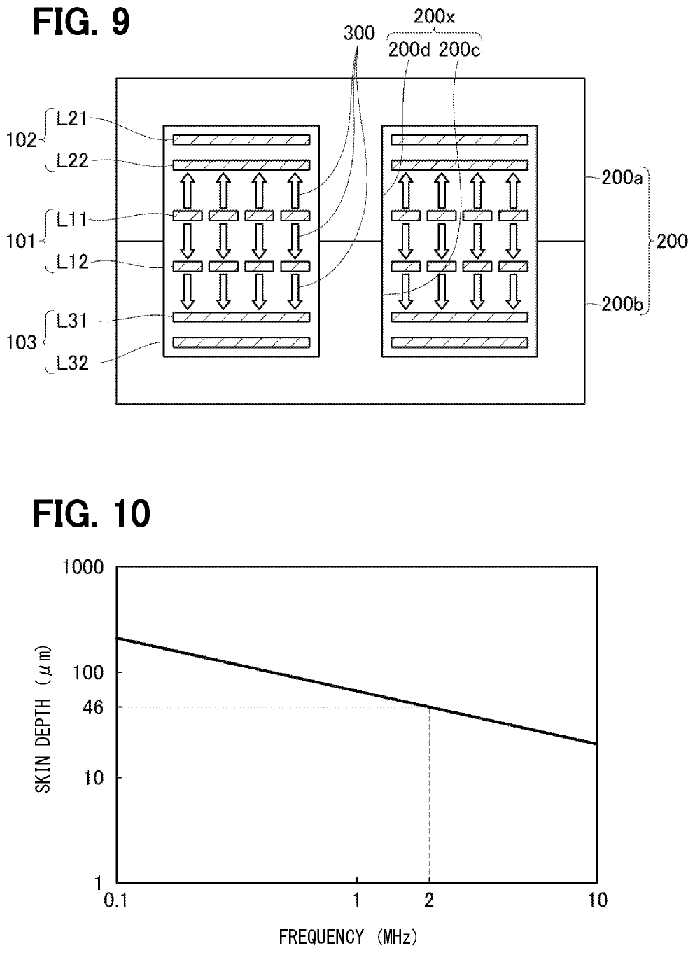

In the present embodiment, the thickness of the winding layer L21 is 140 μm, and the thicknesses of the winding layers L22, L11, L12, L31, and L32 are 105 μm. When a high-frequency alternating current flows through a winding layer, a phenomenon (skin effect) occurs in which a current density decreases from a surface toward a center of the winding due to the influence of a generated magnetic field. FIG. 10 is a diagram illustrating the relationship between a frequency of an alternating current flowing through each of the winding layers L11 to L32 and a skin depth. The skin depth is a depth at which the current becomes 1/e of a current flowing through a conductor surface. In the DC/DC converter 1 of the present embodiment, an alternating current flows at a frequency of about 2 MHz. As shown in FIG. 10, when the frequency of the alternating current is about 2 MHz, the skin depth of each of the winding layers L11 to L32 is about 46 μm. In the present embodiment, since the thickness of each of the winding layers L11 to L32 is 2 times or more and four times or less of the skin depth, it is possible to secure a region having a relatively high current density along the surface portion of the winding. Therefore, the influence of the skin effect on an AC resistance can be effectively reduced.

### Second Embodiment

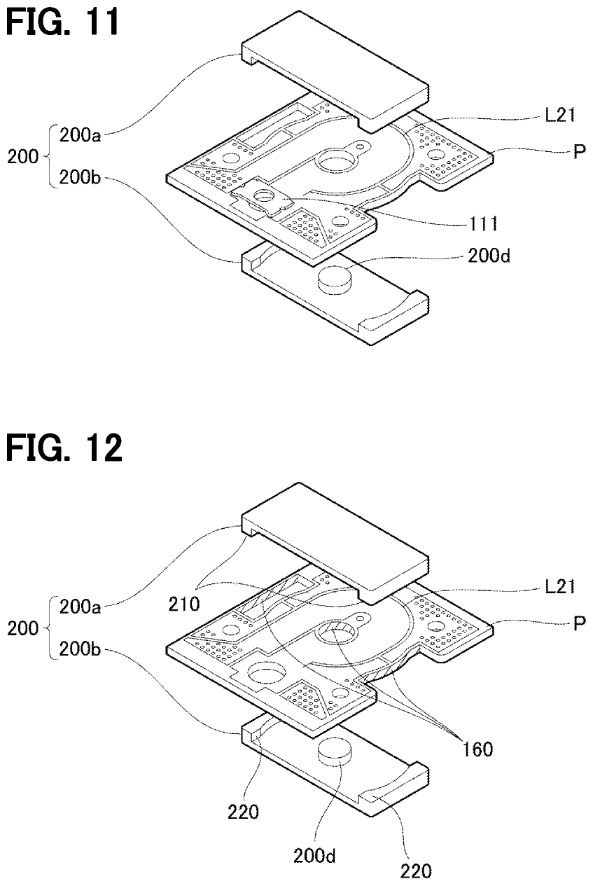

In a second embodiment, as shown in FIG. 11, a fastening terminal 111 is provided to the center tap 110. The center tap 110 is grounded by, for example, a screw through the fastening terminal 111. During the operation of the transformer 100, warpage may occur in each of the winding layers L21 to L32 due to the influence of heat generation. In the configuration of the second embodiment, since the center tap 110 is grounded through the fastening terminal 111, the center tap 110 is less likely to be affected by the warpage of each of the winding layers L21 to L32, and can be grounded more reliably. Therefore, a contact resistance between the center tap 110 and the housing is minimized, and the winding loss can be further reduced.

### Third Embodiment

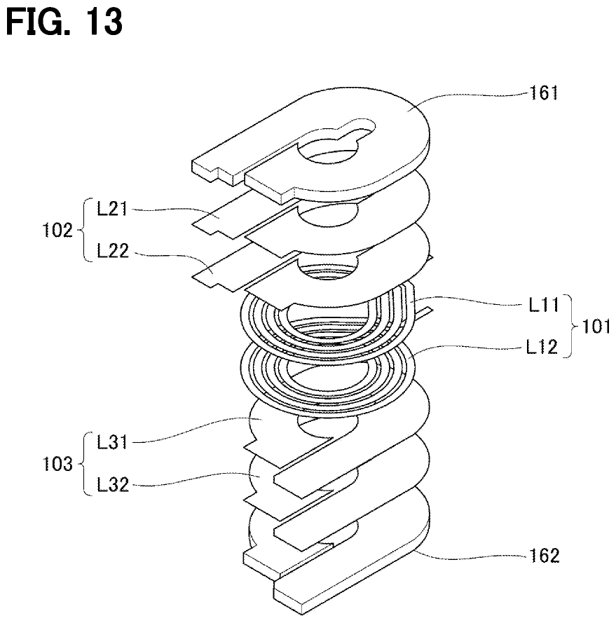

In a transformer of a third embodiment, as shown in FIG. 12, the substrate P has a shield layer 160. The shield layer 160 is, for example, copper plating. The shield layer 160 is disposed on a surface of the substrate P that faces the protruding portions 200c and 200d (that is, the core 200x) when the substrate P is accommodated in the magnetic core component 200. The shield layer 160 is also disposed on surfaces of the substrate P that face the fixing portion 210 of the core portion 200a and the fixing portion 220 of the core portion 200b. In the configuration of the third embodiment, the magnetic flux generated by the displacement current can be shielded by the shield layer 160. Therefore, the influence of the magnetic flux on the core 200x and the fixing portions 210 and 220 is restricted, and the core loss can be further reduced.

In each of the embodiments described above, the thicknesses of the winding layer L22 included in the first secondary winding 102 and the winding layer L31 included in the second secondary winding 103 are equal to the thicknesses of the winding layers L11 and L12 included in the primary winding 101. However, the thicknesses of the winding layers L21 to L32 included in the secondary windings 102 and 103 may also be larger than the thicknesses of the winding layers L11 and L12. For example, the thickness of the winding layers L21 to L32 may be 2 times or more the thickness of the winding layers L11 and L12. In such a configuration, the resistance of the secondary windings 102 and 103 can be further reduced, and the winding loss can be further reduced. In addition, by increasing the thickness of the winding layers included in the secondary windings 102 and 103, the heat dissipation area is increased, and the heat dissipation performance can be improved.

In the embodiments described above, Mn—Zn-based ferrite is used as the material of the core portions 200a and 200b. Mn—Zn-based ferrite has a high magnetic permeability even at a high frequency and is a low-loss magnetic material, so that loss of the transformer 100 can be reduced. In addition, since Mn—Zn-based ferrite can be easily sintered, the size of the magnetic core component 200 (that is, the transformer 100) can be reduced. However, the material included in the core portions 200a and 200b is not particularly limited. For example, a nanocrystalline soft magnetic material may be used. Since the nanocrystalline soft magnetic material has a small crystal grain size, the eddy current loss caused by the magnetic flux due to the displacement current can be further reduced.

In each of the embodiments described above, a liquid crystal polymer may be used as a base material of the substrate P. The liquid crystal polymer has a lower relative permittivity than, for example, an epoxy glass substrate. Therefore, for example, in a case where the insulating layers 11 to 15 having the same thickness as in the embodiments described above are inserted between the winding layers, the parasitic capacitance between the windings can be further reduced, and the core loss can be further reduced.

In each of the embodiments described above, the numbers of winding layers included in the primary winding 101 and the secondary windings 102 and 103 are not limited. For example, the primary winding 101 may be formed of a single winding layer, and the secondary windings 102 and 103 may be formed of three or more winding layers.

As shown in FIG. 13, the transformer 100 may further include bus bars 161 and 162 in addition to the winding layers L11 to L32. In this case, the bus bar 161 may be disposed above the winding layer L21 in the uppermost layer. The bus bar 162 may be disposed below the winding layer L32 in the lowermost layer. The bus bars 161 and 162 can be made of copper, for example. The bus bar 161 may have substantially the same shape as the winding layer L21, and may be electrically connected to the winding layer L21. The bus bar 162 may have substantially the same shape as the winding layer L32, and may be electrically connected to the winding layer L32. The thicknesses of the bus bars 161 and 162 are not particularly limited, and may be, for example, 1000 μm. In such a configuration, the resistance of the secondary windings 102 and 103 can be further reduced. In addition, since the surface areas of the outermost layers are increased, the heat dissipation performance is further improved.

Although the embodiments have been described in detail above, these are merely examples and do not limit the scope of claims. The techniques described in the claims include various modifications and modifications of the specific examples illustrated above. The technical elements described in the present specification or the drawings exhibit technical usefulness alone or in various combinations, and are not limited to the combinations described in the claims at the time of filing. In addition, the techniques illustrated in the present specification or drawings achieve a plurality of objectives at the same time, and achieving one of the objectives itself has technical usefulness.

What is claimed is:

1. A transformer comprising:
a core;
a primary winding wound around the core;
a first secondary winding wound around the core; and
a second secondary winding wound around the core, wherein
the first secondary winding includes a plurality of first winding layers stacked along an axial direction of the core,
the second secondary winding includes a plurality of second winding layers stacked along the axial direction,
the plurality of first winding layers is electrically connected in parallel to each other,
the plurality of second winding layers is electrically connected in parallel to each other,
a distance between the primary winding and the first secondary winding is greater than a distance between adjacent two of the plurality of first winding layers and a distance between adjacent two of the plurality of second winding layers, and
a distance between the primary winding and the second secondary winding is greater than the distance between the adjacent two of the plurality of first winding layers and the distance between the adjacent two of the plurality of second winding layers.

2. The transformer according to claim 1, wherein
the primary winding includes a winding layer, and a number of turns of the winding layer is two or more, and
a number of turns of each of the plurality of first winding layers and a number of turns of each of the plurality of second winding layers are one.

3. The transformer according to claim 1, wherein
the primary winding, the first secondary winding, and the second secondary winding are stacked along the axial direction such that the primary winding is located between the first secondary winding and the second secondary winding.

4. The transformer according to claim 1, wherein
the primary winding includes two third winding layers stacked along the axial direction,
the two third winding layers are electrically connected in series, and
a distance between the two third winding layers is greater than the distance between the adjacent two of the plurality of first winding layers and the distance between the adjacent two of the plurality of second winding layers.

5. The transformer according to claim 1, wherein
each of conductors included in the primary winding, the first secondary winding, and the second secondary winding satisfy a relationship of 2δ≤t≤4δ, where t is a thickness of each of the conductors in the axial direction of the core, and δ is a skin depth of each of the conductors.

6. The transformer according to claim 5, wherein
the thickness of the conductor included in the first secondary winding and the thickness of the conductor included in the second secondary winding are greater than the thickness of the conductor included in the primary winding.

7. The transformer according to claim 1, wherein
each of the first secondary winding and the second secondary winding has a center tap at an end portion, and
the center tap is grounded through a terminal.

8. The transformer according to claim 1, wherein
the plurality of first winding layers and the plurality of second winding layers are disposed on a printed circuit board, and
the printed circuit board has a shield layer on a surface facing the core.
